(19) United States
(12) Patent Application Publication
(10) Pub. No.: US 2008/0176090 A1
(43) Pub. Date: Jul. 24, 2008

(54) Composite thermoplastic articles

(76) Inventors: Andri E. Elia, Chadds Ford, PA (US); Toshikazu Kobayashi, Chadds Ford, PA (US); William Daniel Saunders, Delaware City, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/999,207

(22) Filed: Dec. 4, 2007

Related U.S. Application Data
(60) Provisional application No. 60/875,767, filed on Dec. 19, 2006.

(51) Int. Cl. B32B 27/08

(52) U.S. Cl. 428/474.4

(57) ABSTRACT

Composite articles having good mechanical properties and smooth surface appearance comprising a reinforced thermoplastic polyamide and/or polyester component and a film.

### CROSS REFERENCE TO RELATED APPLICATIONS

This application claims the benefit of U.S. Provisional Application No. 60/875,767, filed Dec. 29, 2006.

### FIELD OF THE INVENTION

The present invention relates to composite articles having good mechanical properties and smooth surface appearance. The articles comprise a reinforced thermoplastic polyamide and/or polyester component and a film.

### BACKGROUND OF THE INVENTION

The design flexibility afforded by many thermoplastic compositions and their relatively light weights and corrosion resistances make them attractive materials for many uses, including for the replacement of metal components in many applications. In many applications, including consumer items such as motor vehicles, recreational vehicles (including boats and other marine transport), appliances, tools (including power tools), electronics, furniture, and toys, the appearance, and in particular the smoothness, of the surface of a thermoplastic part is often important, particularly for customer acceptance of articles containing the thermoplastic parts in visual positions. However, thermoplastic compositions often possess an insufficient combination of stiffness, strength, toughness and/or other physical properties to satisfy the requirements of many of these applications. Additives such as reinforcing agents, fillers, and impact modifiers may be used to improve the physical properties of the compositions, but the addition of such of additives often results in a finished part having a poorer surface appearance. In some cases, it is possible to paint parts to obtain a good surface appearance, but this may require additional manufacturing steps that entail expense and complexity.

It would thus be desirable to obtain a thermoplastic article having good mechanical properties and a smooth surface appearance even when unpainted.

The article Brosius, Dale, “In-Mold Decorating Dresses up Composites,” Composites Technology August 2005, discloses parts made by molding long fiber-reinforced thermoplastics (such as ABS and ABS blends and polyolefins) over preformed decorative films.

### SUMMARY OF THE INVENTION

There is disclosed and claimed herein a composite article, comprising,
(a) a molded part having a surface and comprising a thermoplastic polymeric composition comprising at least one thermoplastic polyamide and/or at least one thermoplastic polyester and at least one reinforcing agent and,
(b) a thermoplastic polymeric film having first and second surfaces opposite each other,
   wherein the surface of the first component (a) is adhered to the first surface of the film (b) and wherein the second surface of film (b) forms a surface of the composite article; and wherein the thermoplastic polymeric composition has a tensile modulus of least about 11 GPa, as measured by ISO method 527-2:1993 at a rate of 5 mm/min on test specimens having a thickness of 4 mm; and a notched Charpy impact strength of at least about 35 kJ/m², as measured by ISO method 179-1:2000.

### DETAILED DESCRIPTION OF THE INVENTION

The composite article of the present invention comprises a first component comprising a molded part comprising a thermoplastic polyamide and/or polyester composition onto at least one surface or partial surface thereof is adhered a thermoplastic polymeric film wherein the surfaces of the article that contain the film have good smoothness.

Suitable thermoplastic polyamides can be condensation products of one or more dicarboxylic acids and one or more diamines, and/or one or more aminocarboxylic acids, and/or ring-opening polymerization products of one or more cyclic lactams. Polyamides may include aliphatic, aromatic, and/or semi-aromatic polyamides.

Suitable dicarboxylic acids include, but are not limited to, adipic acid, azelaic acid, terephthalic acid (abbreviated as “T” in polyamide designations), and isophthalic acid (abbreviated as “I” in polyamide designations). Preferred are dicarboxylic acids having 10 or more carbon atoms, including, but not limited to sebacic acid; dodecanedioic acid, tetradecanedioic acid, pentadecanedioic acid, and the like.

Suitable diamines include, but are not limited to, tetramethylenediamine; hexamethylenediamine; octamethylenediamine; nonamethylenediamine; 2-methylpentamethylenediamine; 2-methyloctamethylenediamine; trimethylhexamethylenediamine; bis(p-aminocyclohexyl)methane; m-xylylenediamine; and p-xylylenediamine. Preferred diamines have 10 or more carbon atoms, including, but not limited to decamethylenediamine; undecamethylenediamine; dodecamethylenediamine; tridecamethylenediamine; tetramethylenediamine; pentamethylenediamine; hexamethylenediamine; and the like.

A suitable aminocarboxylic acid is 11-aminododecanoic acid. Suitable cyclic lactams are caprolactam and laurolactam.

Preferred polyamides include aliphatic polyamides such as polyamide 6; polyamide 6,6; polyamide 4,6; polyamide 6,10; polyamide 6,12; polyamide 11; polyamide 12; polyamide 9,10; polyamide 9,12; polyamide 9,13; polyamide 9,14; polyamide 9,15; polyamide 6,16; polyamide 9,36; polyamide 10,10; polyamide 10,12; polyamide 10,13; polyamide 10,14; polyamide 12,10; polyamide 12,12; polyamide 12,13; polyamide 12,14; polyamide 6,14; polyamide 6,13; polyamide 6,15; polyamide 6,16; polyamide 6,13; and semi-aromatic polyamides such as poly(m-xylylene adipamide) (polyamide MXD, 6) and polyterethalamides such as poly(dodecamethylene terephthalamide) (polyamide 12, T), poly(decamethylene terephthalamide) (polyamide 10, T), poly(nonamethylene terephthalamide) (polyamide 9, T), hexamethylene adipamide/hexamethylene terephthalamide copolyamide (polyamide 6, T/6,6), hexamethylene terephthalamide/2-methylpentamethylene terephthalamide copolyamide (polyamide 6, T/D, T); hexamethylene adipamide/hexamethylene terephthalamide/hexamethylene isophthalamide copolyamide (polyamide 6,6/6, T/6,1); poly(caprolactam-hexamethylene terephthalamide) (polyamide 6/6, T); and copolymers and mixtures of these polymers.

Preferred thermoplastic polyesters (which have mostly, or all, ester linking groups) are normally derived from one or more dicarboxylic acids (or their derivatives such as esters) and one or more diols. In preferred polyesters the dicarboxylic acids comprise one or more of terephthalic acid, isophthalic acid, and 2,6-naphthalene dicarboxylic acid, and the diol component comprises one or more of HO(CH₂)ₙOH (1), 1,4-cyclohexanedimethanol, HO(CH₂CH₂O)ₘCH₂CH₂OH (II), and HO(CH₂CH₂CH₂CH₂O)ₙCH₂CH₂CH₂CH₂OH (III), wherein n is an integer of 2 to 10, m on average is 1 to 4, and z is on average about 7 to about 40. Note that (II) and (III) may be a mixture of compounds in which m and z, respectively, may vary and that since m and z are averages, they do not have to be integers. Other diacids that may be used to form the thermoplastic polyester include sebacic and adipic acids. Hydroxycarboxylic acids such as hydroxybenzoic acid may be used as comonomers. Specific preferred polyesters include poly(ethylene terephthalate) (PET), poly(1,3-propylene terephthalate) (PPT), poly(1,4-butylene terephthalate) (PBT), poly(ethylene naphthalate) (PEN), and poly(1,4-cyclohexyldimethylene terephthalate) (PCT),

The thermoplastic polyester may also be an aliphatic polyester such as poly(lactic acid) (PLA). The term “poly(lactic acid)” includes poly(lactic acid) homopolymers and copolymers of lactic acid and other monomers containing at least 50 mole % of repeat units derived from lactic acid or its derivatives and mixtures thereof having a number average molecular weight of 3,000 to 1,000,000, 10,000 to 700,000, or 20,000 to 600,000. The poly(lactic acid) may contain at least 70 mole percent of repeat units derived from (e.g. made by) lactic acid or its derivatives. The poly(lactic acid) homopolymers and copolymers can be derived from d-lactic acid, l-lactic acid, or a mixture thereof. A mixture of two or more poly(lactic acid) polymers can be used. Poly(lactic acid) may be prepared by the catalyzed ring-opening polymerization of the dimeric cyclic ester of lactic acid, which is referred to as “lactide.” As a result, poly(lactic acid) is also referred to as “polylactide.”

Copolymers of lactic acid are typically prepared by catalyzed copolymerization of lactic acid, lactide or another lactic acid derivative with one or more cyclic esters and/or dimeric cyclic esters.

The thermoplastic polyester may be a poly(alkylene terephthalate)/poly(lactic acid) blend. Preferred blends include poly(ethylene terephthalate)/poly(lactic acid) blends.

The thermoplastic polymer is present in the composition in about 20 to about 60 weight percent, or preferably in about 30 to about 50 weight percent, or more preferably in about 30 to about 40 weight percent, based on the total weight of the composition.

The compositions comprise at least one reinforcing agent. Suitable reinforcing agents include fibrous reinforcing agents such as glass fibers, carbon fibers, and mineral fibers such as wollastonite. Preferred are long fibers, such as glass or carbon fibers that have a number average length of about 2 to about 7 mm after the composition has been formed into the first component. The composition may contain reinforcing agents and fillers in platy, granular, beadlike, and other forms, such as talc, mica, kaolin, glass beads, glass flakes, and the like. The composition may contain nanoparticulate reinforcing agents and fillers such as carbon nanotubes and nanoclays, including montmorillonite and sepiolite.

The reinforcing agent is present in the composition in about 40 to about 80 weight percent, or preferably in about 50 to about 70 weight percent, or more preferably in about 60 to about 70 weight percent, based on the total weight of the composition.

The compositions may comprise electrically conductive additives such as carbon black, carbon fibers, metal-coated carbon fibers, carbon nanotubes, and ion conductive polymeric systems such as those comprising ion conductive polymers and ion sources. Ion conductive polymers include polyetheresteramides and polyesteramide block copolymers. Ion sources include sodium, potassium, and lithium salts. The ion source is preferably present in at least about 200 ppm or more preferably in at least about 1000 ppm, relative to the ion conductive polymer.

The composition may contain additional components such as flame retardants, flame retardant synergists, impact modifiers, stabilizers (such as oxidation, heat, ultraviolet light, etc. stabilizers), colorants (including pigments, dyes, and carbon black), plasticizers, thermally conductive additives, lubricants, nucleating agents, and the like.

The composition used in the present invention is made by melt-blending the components using any known methods. The component materials may be mixed to uniformity using a melt-mixer such as a single or twin-screw extruder, blender, kneader, Banbury mixer, etc. to give a resin composition. Or, part of the materials may be mixed in a melt-mixer, and the rest of the materials may then be added and further melt-mixed until uniform.

The composition has a tensile modulus of at least about 11 GPa, or preferably of at least about 13 GPa, or more preferably of at least about 14 GPa, or yet more preferably of at least about 17 GPa. Tensile modulus is measured according to ISO method 527-2:1993 at a rate of 5 mm/min on test specimens having a thickness of 4 mm.

The composition has a notched Charpy impact strength of at least 10 about 35 kJ/m², or preferably of at least about 40 kJ/m², or more preferably of at least about 50 kJ/m², or yet more preferably of at least about 60 kJ/m², Notched Charpy impact strength is measured according to ISO method 179-1:2000 using a hammer size between 2.0 and 7.5 Joules, inclusive.

The composition preferably has a coefficient of thermal linear expansion of less than or equal to about 50×10⁻⁶/K at 20° C., or more preferably of less than or equal to about 40×10⁻⁶/K at 20° C., or yet more preferably of less than or equal to about 30×10⁻⁶/K at 20° C., or still more preferably of less than or equal to about 20×10⁻⁶/K at 20° C.

The thermoplastic polymeric film may have a single layer or comprise two or more layers, where the two or more layers may be the same or different materials. Where two or more layers are used, one layer may be selected to serve as a tie layer to enhance adhesion of the film to the surface of the first component. As will be understood by those skilled in the art, the composition of the film may be selected to optimize adhesion to the composition of the first component.

The films typically have a thickness of about 8 to about 20 mil. The films are preferably unfilled or filled with nanoparticulate fillers such as nanoclays or electrically conductive fillers, provided that any fillers used do not detract from the surface appearance of the resulting composite article. Examples of electrically conductive fillers include electroconductive or electrostatically dissipative carbon blacks and ion conductive polymers with one or more ion sources.

The nanoclays may be layered silicates, and preferably aluminum and/or magnesium silicates. The nanoclays may be in the form of fibrils, platelets, or other shapes and have a diameter in the range of about 10 to about 5000 nm. The layer thickness is less than about 2 nm. The nanoclays will preferably be swellable clays, meaning that the clays have the ability to absorb water or other polar organic liquids such as methanol and ethanol between the layers. When the liquids are absorbed, the nanoclays swell. At least one dimension of the nanoclay particles will be less than about 20 nm, and preferably less than about 5 nm. The nanoclays contain interlayer cations such as alkali and alkaline earth metal cations. Preferred cations include sodium and calcium ions. The nanoclays are used in an untreated form, meaning that they are not treated with an agent, such as a surfactant, to exchange metal cations present between the layers with organic cations such as ammonium or other onium ions.

Preferred nanoclays are fibrils having number average diameters less than or equal to about 70 nanometers and number average lengths of up to about 1000 nanometers. Examples of preferred nanoclays include sepiolite and smectite clays such as montmorillonite, hectorite, saponite, beidelllite, nontronite, bentonite, saponite, and the like. Both natural and synthetic nanoclays may be used. Natural nanoclay such as Cloisite® Na+ and synthetic smectite clays such as Laponite® are available from Southern Clay Products.

Electroconductive carbon blacks may include electroconductive furnace blacks. It is preferable that the electroconductive carbon black have a specific surface area of at least about 700 m²/g and an oil absorption of from 2 to 4 mL/g. Suitable electroconductive carbon blacks include Ketjenblack® products supplied by Akzo Nobel.

Preferred films comprise polyesters such as poly(ethylene terephthalate) and polyamides, including polyterephthalamides such as hexamethylene adipamide/hexamethylene terephthalamide copolyamide (polyamide 6, T/6,6) and hexamethylene terephthalamide/2-methylpentamethylene terephthalamide copolyamide (polyamide 6, T/D, T).

Examples of suitable components for use as a tie layer include, but are not limited to, ethylene/vinyl alcohol copolymers, ethylene/vinyl acetate copolymers, ethylene/vinyl alcohol/vinyl acetate copolymers, and ionomeric polymers. The ionomeric polymers preferably comprise about 90 to 99 mole percent of repeat units derived from olefins and about 1 to 10 mole percent of repeat units derived from α,β-ethylenically unsaturated monomers having carboxylic moieties wherein the moieties are considered as acid equivalents and are neutralized with metal ions having valences of 1 to 3, inclusive, where the carboxylic acid equivalent is monocarboxylic and are neutralized with metal ions having a valence of 1 where the carboxylic acid equivalent is dicarboxylic. To control the degree of neutralization, metal ions are present in an amount sufficient to neutralize at least 10 percent of the carboxyl moieties. Ionomeric polymers are described in greater detail in U.S. Pat. No. 3,264,272. Ionomeric polymers are supplied under the tradename Surlyn® by E.I. du Pont de Nemours and Co., Wilmington, Del.

Fillers may be added to the polymeric materials comprising the film by any suitable melt-blending method, such as extrusion. The films may be formed using any suitable method known in the art.

The composite articles are preferably formed by molding the composition of the of the first component into the form of a part onto a surface of the film. The film may be used flat, curved, bent, or in any other suitable preformed shape. The film may be preformed into a shape by any method known in the art, including thermoforming.

Such molding may be done by placing the film into a mold and overmolding the composition of the component onto the surface of the film, Suitable molding methods include, but are not limited to, injection molding, compression-injection molding, and compression molding. The composite articles may also be made coextruding the film and the composition of the first component. All or part of the surface of the composite article may comprise the film.

The portion of the surface of the composite article comprising the film preferably contains no further coating such as paint.

The composite articles of the present invention may be used as automotive body panels and other components including fenders, quarter panels, door panels, trunk lids, spoilers, hoods, roofs, bumpers, dashboards, interior panels, interior trim parts, gas caps, wheels, wheel covers, and hubcaps. The articles may be used as lids, covers, bodies, panels, and the like for large appliances such as refrigerators, washing machines, clothes dryers, dishwashers, and the like and small appliances such as electric mixers, steam irons, toasters, microwave ovens, and the like. The articles may also be used in boxes, housings, cabinets, panels and the like for power tools and electronic devices such as mobile telephones, wired telephones, cordless telephones, computers, keyboards, computer monitors, televisions, radios, computer printers, stereo systems, video cassette players, DVD player, and the like. The articles may be used as panels, hoods, housings, casings, engine covers, and the like for motorboat engines, motorcycles, snow mobiles, all-terrain vehicles, jet-skis, farm machinery, and yard maintenance equipment such as lawn mowers, edgers, blowers (including snow blowers), and the like. The articles may be used in furniture such as chairs, tables, and cabinets; in sporting goods such as skis, snowboards, skate boards; as containers for cosmetic articles; and in toys.

In each case the articles may be colored by addition of colorants such as pigments and/or dyes to the composition of the first component and/or the film. The use of colored polymeric materials to form the composite articles of the invention negates the need to paint the articles to obtain the desired surface color and/or appearance.

What is claimed is:

1. A composite article, comprising,
(a) a molded part having a surface and comprising a thermoplastic polymeric composition comprising at least one thermoplastic polyamide and/or at least one thermoplastic polyester and at least one reinforcing agent and,
(b) a thermoplastic polymeric film having first and second surfaces opposite each other,
wherein the surface of the first component (a) is adhered to the first surface of the film (b) and wherein the second surface of film (b) forms a surface of the composite article; and wherein the thermoplastic polymeric composition has a tensile modulus of least about 11 GPa, as measured by ISO method 527-2:1993 at a rate of 5 mm/min on test specimens having a thickness of 4 mm; and a notched Charpy impact strength of at least about 35 kJ/m², as measured by ISO method 179-1:2000.

2. The article of claim 1, wherein the thermoplastic polyamide is a semi-aromatic polyamide.

3. The article of claim 2, wherein the semi-aromatic polyamide is hexamethylene adipamide/hexamethylene terephthalamide copolyamide and/or hexamethylene terephthalamide/2-methylpentamethylene terephthalamide copolyamide.

4. The article of claim 1, wherein the thermoplastic polyester is one or more of poly(ethylene terephthalate), poly(1,3-propylene terephthalate), poly(1,4-butylene terephthalate), poly(ethylene naphthalate), and poly(1,4-cyclohexyldimethylene terephthalate).

5. The article of claim 1, wherein the reinforcing agent is glass fibers and/or carbon fibers.

6. The article of claim 1, wherein the thermoplastic polymeric composition comprises about 20 to about 60 weight percent thermoplastic polymer and about 40 to about 80 weight percent reinforcing agent.

7. The article of claim 1, wherein the thermoplastic polymeric composition comprises about 30 to about 50 weight percent thermoplastic polymer and about 50 to about 70 weight percent reinforcing agent.

8. The article of claim 1, wherein the thermoplastic polymeric composition has a tensile modulus of at least about 13 GPa.

9. The article of claim 1, wherein the thermoplastic polymeric composition has a notched Charpy impact strength of at least about 40 kJ/m².

10. The article of claim 1, wherein the thermoplastic polymeric film comprises at least one polyester and/or polyamide.

11. The article of claim 10, wherein the thermoplastic polymeric film comprises poly(ethylene terephthalate); hexamethylene adipamide/hexamethylene terephthalamide copolyamide; and/or hexamethylene terephthalamide/2-methylpentamethylene terephthalamide copolyamide.

12. The article of claim 1, wherein the thermoplastic polymeric film comprises at least one nanoclay.

13. The article of claim 12, wherein the nanoclay is sepiolite and/or montmorillonite.

14. The article of claim 1, wherein the thermoplastic polymeric film comprises electroconductive carbon black.

15. The article of claim 1, wherein the thermoplastic polymeric film comprises at least one ion conductive polymer.

16. The article of claim 15, wherein the ion conductive polymer is at least one polyetheresteramide.

17. The article of claim 1, wherein the thermoplastic polymeric film comprises at least one layer comprising ethylene/vinyl alcohol copolymers, ethylene/vinyl acetate copolymers, ethylene/vinyl alcohol/vinyl acetate copolymers, and/or ionomeric polymers.
